(19) United States
(12) Patent Application Publication
(10) Pub. No.: US 2003/0055649 A1
(43) Pub. Date: Mar. 20, 2003

(54) Methods for accessing information on personal computers using voice through landline or wireless phones

(76) Inventors: Bin Xu, Milpitas, CA (US); Chi Zhang, Milpitas, CA (US)

Correspondence Address: Bin Xu, 277 Michigan Rd, Milpitas, CA, 95035, US

(21) Appl. No.: 09/954,549

(22) Filed: Sep. 17, 2001

(51) Int. Cl. G10L 21/00

(52) U.S. Cl. 704/270

(57) ABSTRACT

This invention discloses methods and approaches for accessing information residing on ordinary PCs using voice phones calls through telephone lines; either landline telephones or wireless phones can be used. Four techniques are described in this invention to enable effective speech recognition and information retrieval based on normal PC hardware and software platform: i) natural language-based speech recognition; ii) SQL-like information retrieval commands; iii) dynamic dialog-based key content dictations; iv) dynamically generated rule grammars for speech dictations. Through software implementations, these four techniques combined will let ordinary users remotely access the information residing on their PCs by making voice phone calls. Security handling of the voice calls is also disclosed and described in this invention.

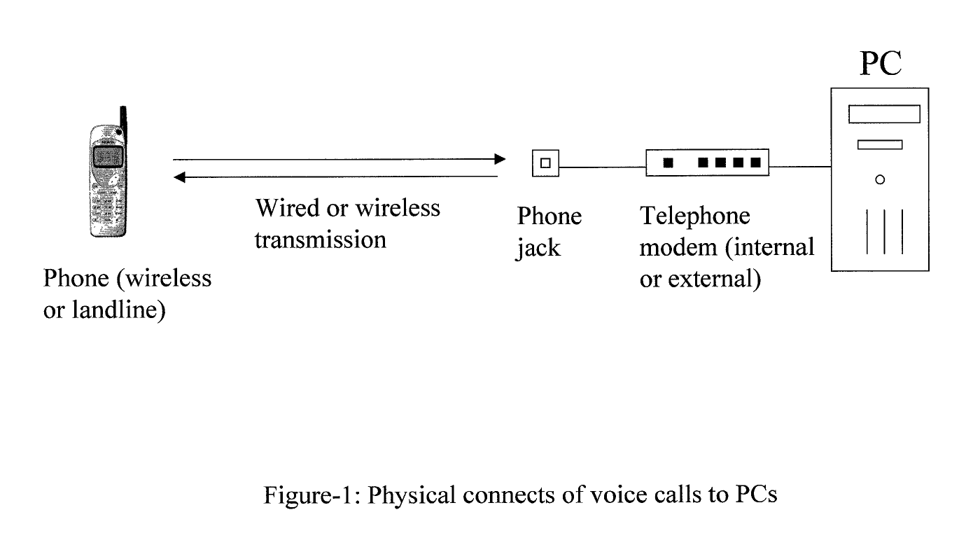

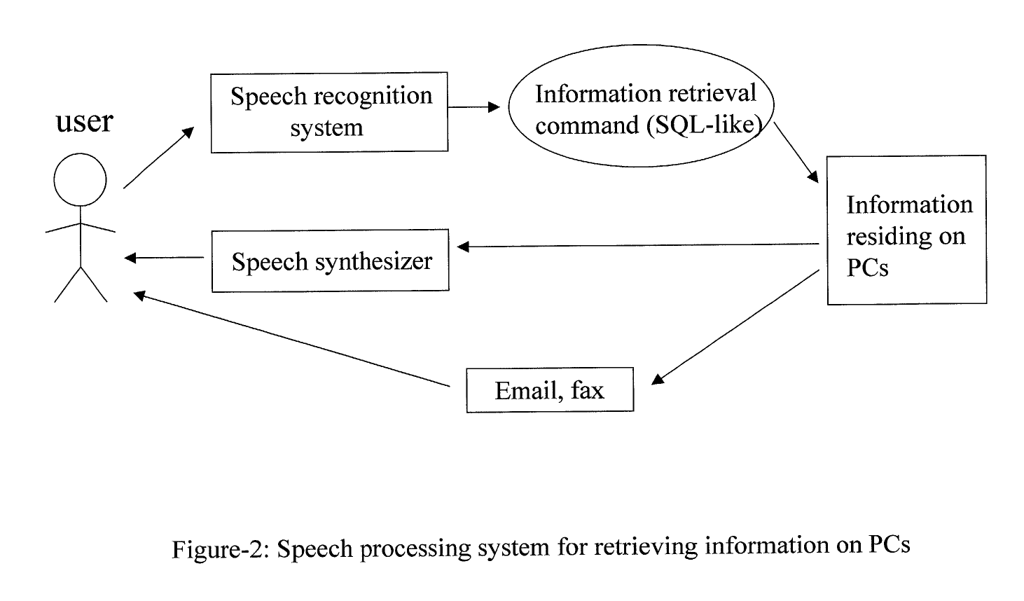

### BACKGROUND OF THE INVENTION

1. Technical Field

The invention relates to methods for speech recognition and natural language processing technologies, to implement practical approaches for remotely accessing and retrieving information on personal computers. This invention enables users to access their PCs using voice phone calls through ordinary landline telephones or wireless phones.

2. Description of the Related Prior Art

Access of personal computers is routine now in people's daily life, for doing office work, communicating with other people, and retrieving important information. However, this kind of access is very limited in that when people are away from homes or offices, they are separated from their machines and thus cannot access the information residing on their PCs (especially the desktop ones). Accessing the information on their PCs is impossible for mobile workers unless some special means are employed, such as using mobile computers installed with certain network communication software to access the target computer. Using handheld computers or palm devices is another workaround. However, these devices cannot directly access people's desktop PCs, even though with the aid of wireless communication capabilities. Furthermore, data synchronization between the handheld devices and PCs has to be conducted on routine basis to align the information between handheld and PCs by physically connecting them through cables. Because PCs installed with Microsoft operating systems and office software are the primary tools for information workers, the inability to access the information, especially the critical information such as emails, calendar, contacts, on their PCs when away from homes or offices, places major inconvenience and difficulties for these people. So far there has been no practical, simple, and convenient way to remotely access the information on PCs directly when people are away from their machines.

Speech recognition technology has come out to be a viable solution for this problem. After many years of work, speech recognition has become mature enough to be deployed in some voice portal applications with the aid of VoiceXML specifications. However, speech recognition technology in general is not there yet to understand and dictate human's natural and continuous speech with complete correctness. In reality, any speech applications are deployed with some strict hardware requirements, such as dedicated telephone boards with DSP chips to enhance voice qualities in telephone applications, or high quality audio microphones for desktop applications. To achieve satisfactory recognition accuracy, VoiceXML specification has been used as a standard for essentially all telephone-based voice portal services. In a typical VoiceXML application, users are limited to speak one of the few several choices prompted by the voice server each time. Each choice usually consists of a single or couple of words, instead of a whole sentence to express a complete meaning. A VoiceXML application resembles a pull-down menu structure. Through layer-by-layer multiple-choice selections using voice, it ultimately leads the users to the final destination. For example, a query of weather forecast in Chicago next Tuesday usually goes through the following three steps of multiple-choice in VoiceXML, i.e., Main menu→Weather→Chicago→next Tuesday. Due to limitations of current speech recognition technologies, voice application user interfaces in VoiceXML are not natural language based, and thus are not user friendly enough to bring convenience for ordinary people for daily usage. Currently, albeit there are voice servers deployed to bring critical or instant-changing information to users, such as stock quote, weather, traffic conditions, etc . . . using such technology to remotely access the information on PCs, however, is still not realized. There are primarily two reasons that prevent this from happening. 1) PCs do not have the dedicated hardware to manage and sustain high quality audio signals, such as the expensive telephone boards installed on voice servers. Considering the fact that voice is transmitted through ordinary telephone lines, this is a hardware drawback for normal PCs that degrades voice quality for speech dictation and therefore the recognition results. 2) The menu structure of VoiceXML is cumbersome to use. It can shy away and frustrate lots of users. The layer-by-layer menu structure limits the VoiceXML technology from being developed into user-friendly applications for accessing the abundant information residing on PCs.

This invention discloses methods and approaches for speech recognition using natural-language-processing technologies. This enhanced technology overcomes the problem of low voice quality due to ordinary PC hardware, and the limitations imposed by VoiceXML standard. It enables a practical PC-based speech platform to let users remotely access their machines using natural language through voice phone calls.

### BRIEF DESCRIPTION OF THE DRAWINGS

FIG.-1: Physical connection of voice calls to PCs.

FIG.-2: Speech processing system for retrieving information on PCs.

### DESCRIPTION OF THE INVENTION

1. Access Information Residing On PCs Through Voice Phone Calls

A normal PC today usually consists of the following software and hardware components: i) operating system (Microsoft Windows); ii) office software, i.e., Microsoft Outlook, Lotus Notes, Word, PowerPoint, etc . . . ; iii) telephone modem. The information residing on PCs that users access on daily basis include emails, calendar, contacts, task lists, and files such as Words, PowerPoint, Excel, etc . . . FIG.-1 discloses the physical connection of how a user uses voice phone calls to access the information on a PC. The telephone modem is used to connect and transfer the voice between the phone and the PC.

The voice from the phone call, once transferred into PC through telephone voice modem and sound card, is fed into speech processing system. This speech processing system dictates the input speech and translates it into information retrieval commands, which are similar to SQL (Structured Query Language) used in database applications. These information retrieval commands fetch the required information residing on PCs, and send it back to users through speech synthesizer or other means, such as sending the requested files by email or fax that the remote user can receive. This flow is implemented by software processes and is described in FIG.-2.

2. Dynamic Dialog-based Natural Language Speech Processing System

To achieve sufficient high recognition accuracy from relatively low quality audio signal transferred by voice modems, and to break the limitations imposed by VoiceXML specifications that prevent normal speech applications from accessing the abundant information on PCs, four technologies are disclosed and described here: i) natural language-based speech recognition; ii) SQL-like information retrieval commands; iii) dynamic dialog-based key content dictations; iv) dynamically generated rule grammars for speech dictations.

I) Natural Language-based Speech Recognition

Contrary to the menu structures in VoiceXML for speech input, users are allowed to speak a whole sentence to express a complete meaning of what information they want to access on their PCs, for example, “please check and tell me the office phone number for Jim Roberts”. Free-form speech dictation usually results in poor dictation results using normal telephone modems. This step of natural language recognition will rely on the following three steps to make it work.

II) SQL-Like Information Retrieval Commands

Similar to SQL for database management, the information access of PC contents will follow specific retrieval commands. The information residing on PCs is categorized and further specified into detailed key entries and their associated attributes. For example, the contact information from Outlook has key entry using each individual person's name. The associated attributes are specific contact information, such as home phone number, office phone number, business address, etc. The abundant information residing on PCs is treated in analogy to a database with different tables, their primary keys, and associated attributes. Once this SQL-like information retrieval commands are constructed for the target PC contents, access of the PC is achieved through calling and executing these retrieval commands. To what level the retrieval commands are defined will determine how details the information and contents residing on PCs can be accessed. Emails, calendar, contacts, files, and task lists, etc . . . are treated as different tables. Each table has its primary key to identify each unit of the information entry. Keys within each table are distinctive from one another, and have their associated attributes to cover the relevant information that the users want to access.

III) Dynamic Dialog-based Key Content Dictations

No matter how good the input voice quality is, free-form speech dictation cannot achieve 100% correctness. Each user has his/her own accent. Phone input can be coupled with environment noise. Current speech engines, even trained by users, cannot achieve dictation accuracy higher than 90%, not to mention the relatively low audio quality due to telephone modems equipped by normal PCs. To compensate the telephone hardware drawback on PCs, and partially get rid of the cumbersome menu-based VoiceXML standard, this invention discloses the dynamic dialog technology to achieve satisfactory dictation results with natural language user interface. This dynamic dialog technology will be used together with IV) as described below.

A natural language input described in I) will start the dialog process. Dictation results from a whole sentence input, in ideal case (all speech words are dictated correctly), will give a completed information retrieval command. This completed command is then ready to retrieve the required information from the PC. However, oftentimes only partial sentence is dictated correctly, with some other words dictated in wrong ways by the speech recognition engine. In this case, the key or some attributes to pull out a complete SQL-like information retrieval command will be missing. For example, “can you check my schedule next Tuesday?” may be dictated as “. . . my schedule next to say”. The attribute to indicate the specific date for a calendar will be missing from the retrieval command, and the system cannot proceed to retrieve the corresponding information. The design of dynamic dialog is aimed to solve this problem. Based on the missing attribute from the retrieval command, the system will then ask the user, through speech synthesizer, “Can you specify the date?” At this time, the user only speaks the missing information, which is the specific date to complete the dialog input that system needs to complete the information retrieval command. This is a more natural and convenient user interface as compared to VoiceXML. The user has a chance to complete his/her information retrieval request in just one sentence input, if he/she speaks clearly with environmental noise down to minimum. However, if the first input is not successful due to some reasons, the system will respond in an intellectual way by interacting with the user with further dialog to complete the information retrieval command. This interactive, dynamic dialog-based speech recognition mechanism brings more pleasant user experience for people as compared to VoiceXML standard. Further more, the dynamically generated rule grammars for speech engine, as described in IV), will sustain sufficient high recognition accuracy when the system prompts the user to answer a specific question. For example, “Tuesday” in this example is dictated wrong in the first recognition. This is because there is larger vocabulary, therefore some more other words that can possibly represent “Tuesday” with similar pronunciations. In the following dialog when system asks “Can you specify the date?” the rule grammar generated dynamically is then greatly narrowed down to words only meaning to dates. “Tuesday” is then recognized correctly with much greater chance.

Dynamic dialog technology relies on the correct attribute recognition as an intermediate step after the first whole sentence dictation. The attribute recognition is realized using the “Entrophy Reduction” technique, which is an invention submitted in patent application Ser. No. 09/596,354 by the same authors.

IV) Dynamically Generated Rule Grammars from PC Contents for Speech Dictations

Grammar rules in speech dictation limit the scope of what user's speech can be represented. Thus it is used extensively in any speech recognition applications to enhance the dictation accuracy. To enable natural language-based information access and retrieval of PC contents, this invention discloses and describes a technique named dynamically generated rule grammars. A rule grammar will generally specify what vocabulary can be spoken, and how they are spoken by following some pre-defined rules. The PC contents are instantly changing with time, and from day to day. For example, the user may create a new piece of contact information with new name in the Outlook, or created a new Microsoft Word file with a new file name called “orange room meeting.doc”. Then next day the user may go on a trip and call his/her PC to ask “please send me the orange room meeting.doc file to me by fax”. In dynamically generated rule grammars, the PC contents are checked instantly, and rule grammars that govern dynamic dialogs are updated instantaneously to reflect the latest content and information available on the PC. In this example, “orange room meeting.doc” will be included in the rule grammar for file name dictation, and the system may ask: “Can you specify the name of the file?” Dynamically generated rule grammars are viable and efficient methods to let users access the latest information residing on their PCs and meanwhile enhance the recognition accuracy.

3. Security Handling of the Voice Call

Security needs to be handled properly to tell and distinguish the incoming call either from the PC user himself or just from an outside person. There are several ways to do it. 1) Without speech recognition: when system picks up the incoming call, it may prompt the user to enter the pass code (usually 4˜8 digits) through DTMF tones using the phone key pad and verify if the caller has the permission to enter the system. Or, the system may perform audio spectra analysis of the incoming voice, to see if there is a voice print (similar to fingerprint) match; 2) with speech recognition: the system may ask the caller to speak out a secret password. This password can be made up of a long sentence to make it difficult for hacker to break out, such as “John's cat slept for 4 hours and a half the day before yesterday”. This secret sentence can be changed through software configurations once in a while. The dynamically generated rule grammars for password recognition and verification will include the new password sentence as a speech rule every time it was generated or changed. To confuse outside callers who might happen to hit the password sentence, the system will also make several variants as speech rules together with the correct password sentence and add them to the dynamically generated rule grammars for password recognition. This will minimize the probability that the speech engine wrongly dictates incoming speech into the right password even though the caller does not know the correct sentence. The variants of the password are made as many as possible with similar voice speech patterns, meaning, or pronunciations.

### References Cited

References Cited
U.S. Patent Documents:

| | | | |
|---|---|---|---|
| 5,224,153 | Jun. 29, 1993 | Katz et al. | 379/93 |
| 5,479,491 | Dec. 26, 1995 | Garcia et al. | 379/88 |
| 5,666,400 | Sep. 9, 1997 | McAllister et al. | 379/88 |
| 5,931,907 | Aug. 3, 1999 | Davies et al. | 709/218 |
| 6,154,527 | Nov. 28, 2000 | Porter et al. | 379/88 |
| 6,233,556 | May 15, 2001 | Teunen et al. | 704/250 |
| 6,246,981 | Jun. 12, 2001 | Papineni et al. | 704/235 |
| 6,278,772 | Aug. 21, 2001 | Bowater et al. | 379/88 |
| 6,282,268 | Aug. 28, 2001 | Hughes et al. | 379/88 |

Other References

IBM Technical Disclosure NN85057034 “Invoking Inference Engines in an Expert System” May 1985.

Perdue et al., “Conversant 1 Voice System: Architecture and Applications”, AT&T Technical Journal, September/October 1986, vol. 65, No.5, pp. 34-37.

A. L. Gorin et al “How may I help you?” Proc. 3rd Workshop on Interactive Voice Technology, Nov. 1, 1996, pp. 57-60.

Denecke et al., “Dialogue Strategies Guiding Users to Their Communicative Goals,” ISSN, 1018-4074, pp. 1339-1342.

World Wide Web Consortium, “Voice Browser Activity and VoiceXML”, web site: http://www.w3c.org/Voice/.

1. Method for remotely accessing the information and contents residing on personal computers through voice phone calls using landline telephones or wireless phones, said method comprising:
physical connection between the PC and the remote user through PC telephone modems and landline telephones or wireless phones, phone lines, internet packet network using VoIP, that transfer the voice audio signal from the remote user to the audio input of the PC for speech recognition;
a speech recognition system installed on PC for recognizing incoming voice, dictating it into information retrieval commands, retrieving and sending the required information back to the remote user through speech synthesizer, or other communication means, such as fax, email, instant message, wireless SMS (short message service), voice messages, VoIP, and automatic alerts through voice phone calls.

2. The method of claim 1 wherein said speech recognition system comprising:
natural language speech input;
SQL-like information retrieval commands;
dynamic dialog-based key content dictations;
dynamically generated rule grammars for speech dictations;
security handling of the voice call.

3. The method of claim 1 wherein said information residing on PCs meaning:
emails, voice messages, calendar and schedules, contact information and address books, task lists, files including word processing, graphics, spreadsheet, and presentations.

4. The method of claim 2 wherein said natural language speech input comprising:
a user speaks a whole sentence once to express a complete meaning for retrieving a specific content or piece of information residing on PC, instead of speaking a single or several words in multiple speech inputs.

5. The method of claim 2 wherein said SQL-like information retrieval commands comprising the steps:
defining SQL-like information retrieval commands;
dictating and translating the incoming speech into the said SQL-like information retrieval commands using dynamic dialog-based key content dictations;
executing the said SQL-like information retrieval commands and sending the retrieved information back to user through speech synthesizer and other communication means, such as email, fax, instant message, voice using VoIP, and voice alert calls.

6. The methods of claim 2 and claim 5 wherein said step of dynamic dialog-based key content dictations comprising steps of:
identifying key contents, such as table or category name, primary key, and attributes for the said SQL-like information retrieval commands from speech input for accessing and retrieving PC contents;
finding missing attributes or key contents from completing the said SQL-like information retrieval command;
prompting and asking the user through speech synthesizer a specific question for inputting the missing attribute or key content;
using dynamically generated rule grammars to dictate and recognize the specific missing attributes or key contents answered by the user through voice input;
iterating the dialogs until a complete SQL-like information retrieval command is complete.

7. The methods of claim 2 and claim 6 wherein said dynamically generated rule grammars comprising:
according to the question raised by the speech system during the said dynamic dialog, instantly changing rule grammars for speech recognition engine to dictate a specific answer from user's speech input;
instantly updating rule grammars for speech recognition engine to reflect and include the latest changes and renewals of the said content and information residing on PCs.

8. The method of claim 5 wherein the said step of defining SQL-like information retrieval commands comprising steps of:
categorizing and specifying the said information and contents residing on PCs into different tables or categories; information within each table or category having similar retrieval commands;
identifying primary key for each table or category so that each piece of information entry within a table or category can be distinctive from one another and have its unique identification;
defining attributes or key contents associated with primary key within a table or category;
information retrieval requests by the user being represented by the said SQL-like information retrieval commands using the said primary key and associated attributes.

9. The method in claim 2 wherein said step of secure handling of voice calls comprising:
speech system prompting the caller to speak out password, usually a sentence; through speech dictation, the system verifying if the caller has the permission to access the PC;
the said password sentence being included as a speech rule in the rule grammar for password dictation;
the rule grammar for password dictation also including variants of the correct password sentence as speech rules; the said variants having similar patterns, meanings, or pronunciations as compared to the correct password sentence;
increasing the number of the said password variant sentences in rule grammar for password dictation to minimize the probability that an outside caller accidentally hit the correct password, hence increasing the voice access security;
increasing the length of the password sentence to enhance the voice access security.
